(19) United States
(12) Patent Application Publication
(10) Pub. No.: US 2020/0031020 A1
(43) Pub. Date: Jan. 30, 2020

(54) BLANK CONTAINER PREFORM

(71) Applicant: Niagara Bottling, LLC, Ontario, CA (US)

(72) Inventor: Jay Clarke Hanan, Ontario, CA (US)

(73) Assignee: Niagara Bottling, LLC, Ontario, CA (US)

(21) Appl. No.: 16/526,683

(22) Filed: Jul. 30, 2019

Related U.S. Application Data
(60) Provisional application No. 62/712,125, filed on Jul. 30, 2018.

(51) Int. Cl. B29B 11/14

(52) U.S. Cl. CPC B29B 11/14; B29L 2031/7158

(57) ABSTRACT

A blank preform for being blow-molded to form a container is provided herein. The blank preform comprises a cylindrical portion that includes a tapered portion that extends to a finish portion. The finish portion includes an opening to an interior of the preform. The finish portion comprises one or more wall thickness portions for blow-molding any of a tamper evidence ledge, one or more threads, a neck portion, and a handling valley. The handling valley facilitates air-conveying the container along a manufacturing line. The cylindrical portion comprises at least one wall thickness suitable for blow-molding any of a base, a portion of a bell, a sidewall, and a shoulder between the sidewall and the bell. The tapered portion comprises one or more wall thickness portions that are suitable for blow-molding any of a portion of the bell, a blown neck, and a blown support ledge.

### PRIORITY

This application claims the benefit of and priority to U.S. Provisional Application, entitled “Blank Container Preform,” filed Jul. 30, 2018 and having application Ser. No. 62/712,125, the entirety of said application being incorporated herein by reference.

### FIELD

Embodiments of the present disclosure generally relate to the field of preforms for plastic containers. More specifically, embodiments of the disclosure relate to preforms and plastic bottles blown from such preforms that are suitable for containing beverages.

### BACKGROUND

Plastic containers have been used as a replacement for glass or metal containers in the packaging of beverages for several decades. The most common plastic used in making beverage containers today is polyethylene terephthalate (PET). Containers made of PET are transparent, thin walled, and have the ability to maintain their shape by withstanding the force exerted on the walls of the container by their contents. PET resins are also reasonably priced and easy to process. PET bottles are generally made by a process that includes the blow-molding of plastic preforms which have been made by injection molding of the PET resin.

Advantages of plastic packaging include lighter weight and decreased breakage as compared to glass, and lower costs overall when taking both production and transportation into account. Although plastic packaging is lighter in weight than glass, there is still great interest in creating the lightest possible plastic packaging so as to maximize the cost savings in both transportation and manufacturing by making and using containers that contain less plastic.

### SUMMARY

Blank container preforms in accordance with embodiments of the invention are disclosed. In one embodiment, a preform suitable for being blow-molded to form a container, includes a grip ring, a finish portion including an opening to an interior of the preform and having at least a first wall thickness, a cylindrical portion including an elongate member that culminates in an end cap and having at least a second wall thickness, and a tapered portion that transitions from a diameter of the finish portion to a smaller diameter of the cylindrical portion and includes at least a third wall thickness.

In a further embodiment, the grip ring is configured to facilitate supporting the preform during blow-molding to form the container.

In another embodiment, the first wall thickness is suitable for blow-molding any one or more of a tamper evidence ledge, one or more threads, a neck portion, and a handling valley.

In a still further embodiment, the handling valley is disposed between the tamper evidence ledge and the one or more threads, the handing valley extending circumferentially around the finish portion.

In still another embodiment, the handling valley includes a portion of the finish portion that has a wall thickness and a diameter that are substantially similar to the wall thickness and diameter of the neck portion.

In a yet further embodiment, the handling valley and the neck portion enable gripping fingers to engage with and support the container during air-conveying the container along a manufacturing assembly.

In yet another embodiment, the one or more threads are configured to rotatably engage with threads disposed within the cap.

In a further embodiment again, the tamper evidence ledge facilitates passing a tamper-evident ring portion of a cap over the tamper evidence ledge during assembly of the cap onto the container, and the tamper evidence ledge is configured to retain the tamper-evident ring positioned below the tamper evidence ledge during loosening of the cap, causing the tamper-evident ring to break loose from the cap.

In another embodiment again, the tamper evidence ledge and the tamper-evident ring cooperate to indicate that the cap has not been previously loosened after being installed by the manufacturer.

In a further additional embodiment, the third wall thickness smoothly transitions from the first wall thickness to the second wall thickness of the cylindrical portion, the second wall thickness and the third wall thickness being configured for being blow-molded into a predetermined shape and size of the container.

In another additional embodiment, the container includes a base, a bell, a sidewall between the base and the bell, a shoulder between the sidewall and the bell, a blown neck, and a blown support ledge between the blown neck and the finish portion.

In a still yet further embodiment, the blown support ledge includes a sloped upper surface that is configured to provide clearance for gripping the neck portion during air-conveying the container.

In a number of embodiments, a preform suitable for being blow-molded to form a container includes a finish portion configured to form any one or more of a tamper evidence ledge, one or more threads, a neck portion, and a handling valley, a cylindrical portion configured to form any one or more of a base, at least a lower portion of a bell, a sidewall between the base and the bell, and a shoulder between the sidewall and the bell, and a tapered portion configured to form any one or more of at least an upper portion of the bell, a blown neck, and a blown support ledge.

In a still further embodiment again, also including a grip ring configured to facilitate supporting the preform during blow-molding to form the container.

In still another embodiment again, the finish portion includes one or more wall thickness portions that are suitable for forming any one or more of the tamper evidence ledge, the one or more threads, the neck portion, and the handling valley.

In a still further additional embodiment, the cylindrical portion includes at least one wall thickness suitable for being blow-molded into a predetermined shape and size of the container.

In still another additional embodiment, the cylindrical portion culminates in an end-cap having the at least one wall thickness.

In a yet further embodiment again, the tapered portion includes one or more wall thickness portions that are suitable for blow-molding any one or more of at least the upper portion of the bell, the blown neck, and the blown support ledge.

In yet another embodiment again, at least one of the one or more wall thickness portions is suitable for blow-molding the blown support ledge.

### BRIEF DESCRIPTION OF THE DRAWINGS

The drawings refer to embodiments of the present disclosure in which:

FIG. 1 illustrates a side plan view of an exemplary embodiment of a blank preform suitable for being blow-molded to form a bottle in accordance with the present disclosure;

FIG. 2 illustrates a side plan view of an exemplary embodiment of a bottle that is formed by way of blow-molding the preform illustrated in FIG. 1; and

FIG. 3 illustrates a close-up side plan view of a blow-molded finish comprising the bottle of FIG. 2.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first preform,” may be made. However, the specific numeric reference should not be interpreted as a literal sequential order but rather interpreted that the “first preform” is different than a “second preform.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Disclosed herein are articles, including preforms and containers, which utilize less plastic in their construction while maintaining the ease of processing and excellent structural properties associated with current commercial designs.

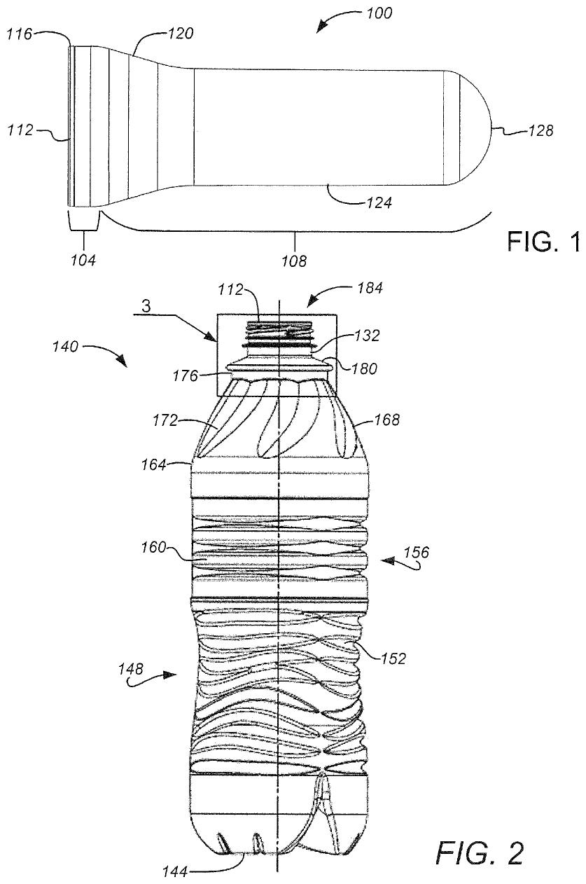

FIG. 1 illustrates an exemplary embodiment of a blank preform 100 suitable for being blow-molded to faun a container, or a plastic bottle, according to the present disclosure. The blank preform 100 preferably is made of material approved for contact with food and beverages such as virgin PET and can be of any of a wide variety of shapes and sizes. The blank preform 100 shown in FIG. 1 is of the type which will form a 12-16 oz. beverage bottle, but as will be understood by those skilled in the art, other preform configurations may be used depending upon the desired configuration, characteristics and use of the final article. The blank preform 100 may be made by injection molding methods, without limitation.

The blank preform 100 includes a finish portion 104 and a body portion 108, formed monolithically (i.e., as a single, or unitary, structure). Advantageously, the monolithic arrangement of the preform 100, when blow-molded into a bottle, provides greater dimensional stability and improved physical properties in comparison to a preform constructed of separate neck and body portions that are bonded together.

The finish portion 104 begins at an opening 112 to an interior of the preform 100 and extends to the body portion 108. The opening 112 is surrounded by a grip ring 116 that is configured to facilitate supporting the preform 100 during blow-molding the preform to faun a container. In some embodiments, the grip ring 116 may be substantially larger than the grip ring illustrated in FIG. 1, depending on the degree of support that is required during the blow-molding process. In some embodiments, excess material may be removed from the grip ring 116 as needed after the preform 100 has been blow-molded to form the container.

The body portion 108 includes a tapered portion 120 that extends from the finish portion 104 and extends to a cylindrical portion 124. The tapered portion 120 comprises a smooth transition from an exterior diameter of the finish portion 104 to a relatively smaller exterior diameter of the cylindrical portion 124 of the preform 100. The cylindrical portion 124 is a generally elongate member that culminates in an end cap 128. In some embodiments the body portion 108 may be generally cylindrical, and the end cap 128 may be conical or frustoconical and may also be hemispherical, and the very terminus of the end cap 128 may be flattened or rounded.

In some embodiments, a wall thickness of the cylindrical portion 124 is substantially uniform throughout the cylindrical portion 124 and the end cap 128. At least a portion of the tapered portion 120 adjacent to the cylindrical portion 124 may have a wall thickness that generally decreases from the wall thickness of the cylindrical portion 124 to a relatively thinner wall thickness of a neck portion 132 (see FIG. 3). As will be appreciated, the wall thickness of the cylindrical portion 124 is relatively greater than the wall thickness of the neck portion 132 so as to provide a wall thickness at the desired dimensions of a finished product after the blank preform 100 is blow-molded into the shape and size of a bottle. As such, the wall thickness throughout most of the body portion 108 will depend upon the overall size of the preform 100 and the wall thickness and overall size of the resulting container.

Moreover, the wall thickness throughout the finish portion 104 will depend upon the shape and size of the blown finish portion comprising the finished bottle after the blank preform 100 is blow-molded into the shape and size of the bottle. As such, in some embodiments, the finish portion 104 comprises one or more wall thickness portions that are suitable for forming various structural features comprising the finish of the bottle, including, but not necessarily limited to, a tamper evidence ledge, one or more threads for engaging a closure or a cap, the neck portion 132, a handling valley, and the like. Further, in some embodiments, at least a portion of the tapered portion 120 adjacent to the finish portion 104 comprises one or more wall thickness portions that are suitable for blow-molding any one or more of at least the upper portion of a bell of the bottle, a blown neck, and a blown support ledge, as described herein, and without limitation.

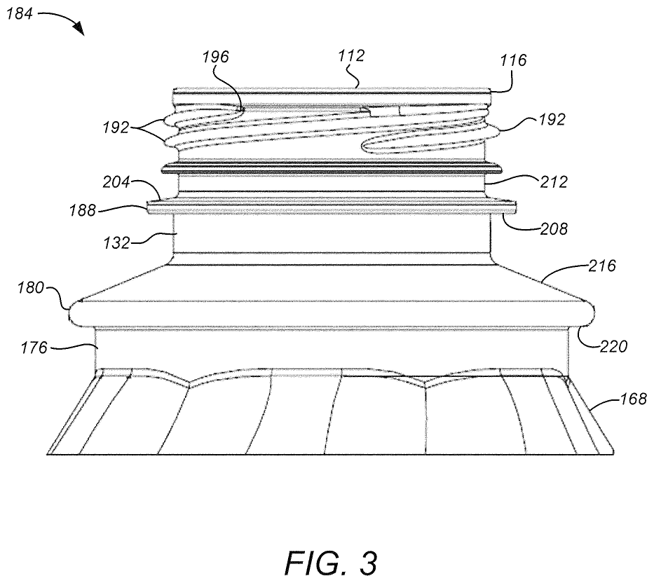

FIG. 2 illustrates a side plan view of an exemplary embodiment of a container, such as a bottle 140, that is formed by way of blow-molding the blank preform 100 shown in FIG. 1. The bottle 140 comprises a base 144 that extends up to a grip portion 148. The grip portion 148 comprises a plurality of grip portion ribs 152 (i.e., sidewall ribs). In a variety of embodiments, the plurality of grip portion ribs 152 generally vary in depth, and swirl or angulate around the grip portion 148. A label portion 156 is connected to the grip portion 148 and comprises one or more label panel ribs 160 (i.e., sidewall ribs). The label panel portion 156 typically transitions into a shoulder 164, which can itself connect to a bell 168. In the embodiment illustrated in FIG. 2, the bell 168 comprises a plurality of design features 172. In other embodiments, however, the bell 168 may include various other design features, or may be smooth and generally unornamented or structurally reinforced. The bell 168 connects to a blown neck 176, which comprises a substantially cylindrical portion that connects to a blown support ledge 180 that connects to the neck portion 132 of a blow-molded finish 184. As shown in FIG. 2, the blow-molded finish 184 is adapted to receive a closure, such as by way of non-limiting example, a container cap or bottle cap, so as to seal contents within the bottle 140. The blow-molded finish 184 generally defines the opening 112 that leads to an interior of the bottle 140 for containing a beverage, or other contents, such as (but not limited to) any of a variety of carbonated soft drinks.

FIG. 3 illustrates a close-up side plan view of the blow-molded finish 184 comprising the bottle 140 of FIG. 2. In many embodiments, the blow-molded finish 184 begins at the opening 112 to the interior of the bottle 140 and extends to and includes a tamper evidence ledge 188. The blow-molded finish 184 is further characterized by the presence of one or more threads 192 configured to provide a means to fasten a closure, such as a cap, to the bottle 140 produced from the blank preform 100. As such, the threads 192 are configured to rotatably engage with similar threads disposed within the cap to provide a way to seal contents within the bottle. In the embodiment illustrated in FIG. 3, each of the threads 192 generally extends along a section of the circumference of the blow-molded finish 184 and approaches the tamper evidence ledge 188. Thus, when the threads of a cap are engaged with the threads 192, and the cap is rotated in a clockwise direction, the cap advances toward the tamper evidence ledge 188.

With continuing reference to FIG. 3, each of the one or more threads 192 begins at a thread start 196 and extends along an angular section of the blow-molded finish 184. The thread start 196 is configured to guide the thread 192 into a space, or valley 200, between adjacent threads of the cap so as to threadably engage the cap with the blow-molded finish 184. Further, the threads 192 generally are disposed adjacently to one another and are spaced uniformly around the circumference of the blow-molded finish 184. In some embodiments, wherein three threads 192 are disposed around the blow-molded finish 184, the thread starts 196 of adjacent threads 192 are spaced at substantially 120-degree intervals around the perimeter of the blow-molded finish 184. As will be appreciated, however, more or less than three threads 192 may be incorporated into the blow-molded finish 184 without deviating beyond the scope of the present disclosure.

The tamper evidence ledge 188 comprises a rounded upper portion 204 and a substantially flat lower portion 208. As will be appreciated, the rounded upper portion 204 facilitates passing a tamper-evident ring portion of the cap over the tamper evidence ledge 188 during assembly of the cap onto the bottle 140. The flat lower portion 208 is configured to retain the tamper-evident ring positioned below the tamper evidence ledge 188 during loosening of the cap. For example, when the cap is initially installed onto the bottle 140 by a manufacturer, the tamper-evident ring easily passes over the tamper evidence ledge 188 due to the rounded upper portion 204. In a variety of embodiments, when an end-user later loosens the cap, the flat lower portion 208 retains the tamper-evident ring below the tamper evidence ledge 188, such that it may facilitate the tamper-evident ring to break loose from the cap. Thus, the flat lower portion 208 of the tamper evidence ledge 188 and the tamper-evident ring of the cap cooperate in many embodiments to display an indicator to the end-user that the cap has not been previously loosened after being installed by the manufacturer. It should be understood, however, that the tamper evidence ledge 188 is not limited to being coupled with tamper-evident rings, as described above, but rather the tamper evidence ledge 188 may be configured to operate with any of various devices for indicating whether or not the bottle 140 has been previously opened.

Disposed between the tamper evidence ledge 188 and the threads 192 is a handling valley 212 that extends circumferentially around the blow-molded finish 184. Further, the handling valley 212 comprises a portion of the blow-molded finish 184 that has a diameter that is substantially similar to the diameter of the neck portion 132, below the tamper evidence ledge 188. As such, the handling valley 212 and the neck portion 132 advantageously enable gripping fingers to engage with and support the bottle 140 during air-conveying the bottle along a manufacturing assembly. For example, a first pair of gripping fingers can extend into the handling valley 212 to support the bottle 140 at a first station of a manufacturing line. Then, upon being conveyed to a second station, a second pair of gripping fingers can extend around the neck portion 132, below the tamper evidence ledge 188, while the first pair of gripping fingers are removed from the handling valley 212. Similarly, upon arriving at a third station, a third pair of gripping fingers can engage with the handling valley 212 while the second pair of gripping fingers are removed from the neck portion 132. Thus, the bottle 140 can be transported along the manufacturing line by alternatingly engaging gripping fingers with the handling valley 212 and the neck portion 132. The method of passing off preforms via an alternating method described above is advantageous as a preform may be exposed to numerous processes within numerous machines during the process of forming a final bottle shape. This allows the manufacturer to have more flexibility when designing and implementing various manufacturing methods and setups.

As will be appreciated, the handling valley 212 provides a separation between the tamper evidence ledge 188 and the threads 192 suitable for receiving the pair of gripping fingers, as described above. In general, the separation must be large enough to allow the gripping fingers to easily pass between the tamper evidence ledge 188 and the threads 192. Further, the neck portion 132 provides a separation between the tamper evidence ledge 188 and the blown support ledge 180 that allows the gripping fingers to engage with the neck portion 132. Furthermore, the blown support ledge 180 includes a sloping upper surface 216 and a substantially flat lower surface 220. As will be recognized, the sloping upper surface 216 of the blown support ledge 180 facilitates the gripping fingers engaging the neck portion 132 without any interference by the blown support ledge 180. As such, any of various separations, greater than the width of the gripping fingers, may be disposed between the tamper evidence ledge 188 and the blown support ledge 180, and between the tamper evidence ledge 188 and the threads 192, without limitation and without deviating beyond the scope of the present disclosure. As can be understood, the manufacturing of gripping fingers with smaller overall heights can allow for a reduction in the size of the handling valley 212 and thus the overall amount of plastic required in the preform 100 and resulting bottle 140.

The articles described herein may be made from any suitable thermoplastic material, such as polyesters including polyethylene terephthalate (PET), polyolefins, including polypropylene and polyethylene, polycarbonate, polyamides, including nylons (e.g. Nylon 6, Nylon 66, MXD6), polystyrenes, epoxies, acrylics, copolymers, blends, grafted polymers, and/or modified polymers (monomers or portion thereof having another group as a side group, e.g. olefin-modified polyesters). These materials may be used alone or in conjunction with each other. More specific material examples include, but are not limited to, ethylene vinyl alcohol copolymer (“EVOH”), ethylene vinyl acetate (“EVA”), ethylene acrylic acid (“EAA”), linear low density polyethylene (“LLDPE”), polyethylene 2,6- and 1,5-naphthalate (“PEN”), polyethylene terephthalate glycol (“PETG”), poly(cyclohexylenedimethylene terephthalate), polystryrene, cycloolefin, copolymer, poly-4-methylpentene-1, poly(methyl methacrylate), acrylonitrile, polyvinyl chloride, polyvinylidine chloride, styrene acrylonitrile, acrylonitrile-butadiene-styrene, polyacetal, polybutylene terephthalate, ionomer, polysulfone, polytetra-fluoro ethylene, polytetramethylene 1,2-dioxybenzoate and copolymers of ethylene terephthalate and ethylene isophthalate. In certain embodiments preferred materials may be virgin, pre-consumer, post-consumer, regrind, recycled, and/or combinations thereof.

In some embodiments, polypropylene also refers to clarified polypropylene. As used herein, the term “clarified polypropylene” is a broad team and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors helps prevent and/or reduce crystallinity, which contributes to the haziness of polypropylene, within the polypropylene. Alternatively, nucleation inhibitors may be added to polypropylene.

As used herein, “PET” includes, but is not limited to, modified PET as well as PET blended with other materials. One example of a modified PET is IP A-modified PET, which refers to PET in which the IP A content is preferably more than about 2% by weight, including about 2-10% IP A by weight, also including about 5-10% IP A by weight. In another modified PET, an additional comonomer, cylohexane dimethanol (“CHDM”) is added in significant amounts (e.g. approximately 40% by weight or more) to the PET mixture during manufacture of the resin.

Additives may be included in articles herein to provide functional properties to the resulting containers. Such additives include those providing enhanced gas barrier, UV protection, scuff resistance, impact resistance and/or chemical resistance. Preferred additives may be prepared by methods known to those of skill in the art. For example, the additives may be mixed directly with a particular material, or they may be dissolved/dispersed separately and then added to a particular material. Additives may be present in an amount up to about 40% of the material, also including up to about 30%, 20%, 10%, 5%, 2% and 1% by weight of the material. In some embodiments, additives may be present in an amount less than or equal to 1% by weight, such ranges of materials including, but not limited to, about 0.01% to about 1%, about 0.01% to about 0.1%, and about 0.1% to about 1% by weight.

Another possible additive is microparticulate clay or graphene based materials. These materials comprise tiny, micron or sub-micron size (diameter), particles of materials which enhance the barrier and/or mechanical properties of a material by creating a more tortuous path for migrating gas molecules, such as oxygen or carbon dioxide, to take as they permeate a material and/or providing added stiffness. In some embodiments, nanoparticulate material is present in amounts ranging from 0.05 to 1% by weight, including 0.1%, 0.5% by weight and ranges encompassing these amounts. In some embodiments, nanoparticles comprise monmorillonite that may be modified with a ternary or quaternary ammonium salt. In some embodiments, such particles comprise organoclays as described in U.S. Pat. No. 5,780,376, the entire disclosure of which is hereby incorporated by reference and forms part of the disclosure of this application. Other suitable organic and inorganic microparticulate clay based or nano-sized products may also be used. Both man-made and natural products are also suitable.

In some embodiments, the UV protection properties of the material may be enhanced by the addition of one or more additives. In one embodiment, the UV protection material used provides UV protection up to about 350 nm or less, preferably about 370 nm or less, more preferably about 400 nm or less. The UV protection material may be used as an additive with layers providing additional functionality or applied separately as a single layer. In some embodiments, additives providing enhanced UV protection are present in the material from about 0.05 to 20% by weight, but also including about 0.1%, 0.5%, 1%, 2%, 3%, 5%, 10%, and 15% by weight, and ranges encompassing these amounts. In some embodiments, the UV protection material is added in a form that is compatible with the other materials. In some embodiments, a preferred UV protection material comprises a polymer grafted or modified with a UV absorber that is added as a concentrate. Other preferred UV protection materials include, but are not limited to, benzotriazoles, phenothiazines, and azaphenothiazines. UV protection materials may be added during the melt phase process prior to use, such as prior to injection molding or extrusion.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A preform suitable for being blow-molded to form a container, the preform comprising:
a grip ring;
a finish portion including an opening to an interior of the preform and having at least a first wall thickness;
a cylindrical portion comprising an elongate member that culminates in an end cap and having at least a second wall thickness; and
a tapered portion that transitions from a diameter of the finish portion to a smaller diameter of the cylindrical portion and comprises at least a third wall thickness.

2. The preform of claim 1, wherein the grip ring is configured to facilitate supporting the preform during blow-molding to form the container.

3. The preform of claim 1, wherein the first wall thickness is suitable for blow-molding any one or more of a tamper evidence ledge, one or more threads, a neck portion, and a handling valley.

4. The preform of claim 3, wherein the handling valley is disposed between the tamper evidence ledge and the one or more threads, the handing valley extending circumferentially around the finish portion.

5. The preform of claim 3, wherein the handling valley comprises a portion of the finish portion that has a wall thickness and a diameter that are substantially similar to the wall thickness and diameter of the neck portion.

6. The preform of claim 5, wherein the handling valley and the neck portion enable gripping fingers to engage with and support the container during air-conveying the container along a manufacturing assembly.

7. The preform of claim 3, wherein the one or more threads are configured to rotatably engage with threads disposed within the cap.

8. The preform of claim 3, wherein the tamper evidence ledge facilitates passing a tamper-evident ring portion of a cap over the tamper evidence ledge during assembly of the cap onto the container, and wherein the tamper evidence ledge is configured to retain the tamper-evident ring positioned below the tamper evidence ledge during loosening of the cap, causing the tamper-evident ring to break loose from the cap.

9. The preform of claim 8, wherein the tamper evidence ledge and the tamper-evident ring cooperate to indicate that the cap has not been previously loosened after being installed by the manufacturer.

10. The preform of claim 1, wherein the third wall thickness smoothly transitions from the first wall thickness to the second wall thickness of the cylindrical portion, the second wall thickness and the third wall thickness being configured for being blow-molded into a predetermined shape and size of the container.

11. The preform of claim 10, wherein the container comprises a base, a bell, a sidewall between the base and the bell, a shoulder between the sidewall and the bell, a blown neck, and a blown support ledge between the blown neck and the finish portion.

12. The preform of claim 11, wherein the blown support ledge includes a sloped upper surface that is configured to provide clearance for gripping the neck portion during air-conveying the container.

13. A preform suitable for being blow-molded to form a container, the preform comprising:
a finish portion configured to form any one or more of a tamper evidence ledge, one or more threads, a neck portion, and a handling valley;
a cylindrical portion configured to form any one or more of a base, at least a lower portion of a bell, a sidewall between the base and the bell, and a shoulder between the sidewall and the bell; and
a tapered portion configured to form any one or more of at least an upper portion of the bell, a blown neck, and a blown support ledge.

14. The preform of claim 13, further comprising a grip ring configured to facilitate supporting the preform during blow-molding to form the container.

15. The preform of claim 13, wherein the finish portion comprises one or more wall thickness portions that are suitable for forming any one or more of the tamper evidence ledge, the one or more threads, the neck portion, and the handling valley.

16. The preform of claim 13, wherein the cylindrical portion comprises at least one wall thickness suitable for being blow-molded into a predetermined shape and size of the container.

17. The preform of claim 16, wherein the cylindrical portion culminates in an end-cap having the at least one wall thickness.

18. The preform of claim 13, wherein the tapered portion comprises one or more wall thickness portions that are suitable for blow-molding any one or more of at least the upper portion of the bell, the blown neck, and the blown support ledge.

19. The preform of claim 18, wherein at least one of the one or more wall thickness portions is suitable for blow-molding the blown support ledge.
